(19) United States
(12) Patent Application Publication
(10) Pub. No.: US 2025/0047664 A1
(43) Pub. Date: Feb. 6, 2025

(54) SYSTEM, AUTHENTICATION TERMINAL, CONTROL METHOD OF AUTHENTICATION TERMINAL, AND STORAGE MEDIUM

(71) Applicant: NEC Corporation, Minato-ku, Tokyo (JP)

(72) Inventors: Kyohei SAKAKI, Tokyo (JP); Shin OGURA, Tokyo (JP); Daisuke KAWASAKI, Tokyo (JP); Kaori YAMANE, Tokyo (JP); Osamu SAKAGUCHI, Tokyo (JP)

(73) Assignee: NEC Corporation, Minato-ku, Tokyo (JP)

(21) Appl. No.: 18/691,123

(22) PCT Filed: Sep. 29, 2021
(86) PCT No.: PCT/JP2021/035858

§ 371 Date: Mar. 12, 2024

(51) Int. Cl. H04L 9/40

(52) U.S. Cl. CPC H04L 63/0861

(57) ABSTRACT

System includes authentication terminal, server apparatus, and terminal. The terminal stores first biometric information of user and qualification information on qualification required to receive service from the authentication terminal. When the terminal is ready to communicate with the authentication terminal, the terminal transmits user information notification including first biometric information and qualification information to the authentication terminal. When the authentication terminal provides the service to the user, the authentication terminal acquires second biometric information of the user and identifies the user to be provided the service by matching processing using acquired second biometric information and first biometric information included in user information notification. The authentication terminal transmits qualification information of the identified user to the server apparatus. The server apparatus determines validity of qualification information and transmits result of the determination to the authentication terminal. The authentication terminal provides the service to the user when qualification information is valid.

### TECHNICAL FIELD

The present invention relates to a system, an authentication terminal, a control method of an authentication terminal, and a storage medium.

### BACKGROUND ART

Various technologies related to biometric authentication are being developed.

For example, Patent Literature 1 describes an authentication apparatus, an authentication method, a program, and an information processing apparatus that enable a user to be authenticated using biometric information without storing the biometric information. The authentication apparatus of the Patent Literature 1 performs a user authentication by comparing correct answer information with answer information generated by converting information for authentication, which is generated by converting basic information using biometric information for generation, by using biometric information for authentication.

Patent Literature 2 describes providing a face verification system, a face verification apparatus, a face verification method, and a recording medium that enable a smooth registration of a registered face image when a registered face image to be used for a verification in a face authentication does not exist. The face matching system of the Patent Literature 2 includes a reading unit, a photographing unit, a face detection unit, a face matching unit, and a registration unit. The reading unit reads identification information from a medium possessed by a person to be authenticated. The photographing unit acquires an image. The face detection unit detects a face image from the image acquired by the photographing unit as a detected face image. When there is a registered face image associated with the identification information read by the reading unit, the face matching unit matches the detected face image detected by the face detection unit with the registered face image. The face matching unit matches the detected face image photographed by the photographing unit before the reading unit reads the identification information with the registered face image. When there is no registered face image associated with the identification information read by the reading unit, the registration unit registers the detected face image photographed by the photographing unit before the reading unit reads the identification information as the registered face image.

### CITATION LIST

### Patent Literature

[PTL 1]International Publication WO2021/049321
[PTL 2]International Publication WO2017/146161

### SUMMARY OF INVENTION

### Technical Problem

In order to realize biometric authentication, it is necessary to register biometric information of a person to be authenticated (for example, a face image and a feature value generated from the face image) in an authentication system. However, since biometric information is immutable information that identifies an individual, a more secure authentication system is required. In other words, as disclosed in Patent Literatures 1 and 2, when the system side centrally manages (unified management) biometric information of a user, the system is not highly secure because of a significant loss in an event of an information leakage.

It is a main object of the present invention to provide a system, an authentication terminal, a control method of an authentication terminal, and a storage medium that contribute to achieving a more secure authentication system.

### Solution to Problem

According to a first aspect of the present invention, there is provided a system, including: an authentication terminal; a server apparatus; and a terminal that stores first biometric information of a user and qualification information on a qualification required to receive a service from the authentication terminal, wherein the terminal transmits a user information notification including the first biometric information and the qualification information to the authentication terminal when the terminal is ready to communicate with the authentication terminal, wherein the authentication terminal acquires second biometric information of the user when the authentication terminal provides the service to the user, identifies the user to be provided the service by a matching processing using the acquired second biometric information and the first biometric information included in the user information notification and transmits the qualification information of the identified user to the server apparatus, wherein the server apparatus determines a validity of the qualification information and transmits a result of the determination to the authentication terminal, and wherein the authentication terminal provides the service to the user when the qualification information is valid.

According to a second aspect of the present invention, there is provided an authentication terminal, including: a receiving unit that receives a user information notification including first biometric information and qualification information from a terminal that stores the first biometric information of a user and the qualification information on a qualification required to receive a service; a biometric information acquisition unit that acquires second biometric information of the user when the authentication terminal provides the service to the user; a service providing availability determination unit that identifies the user to be provided the service by a matching processing using the acquired second biometric information and the first biometric information included in the user information notification and receives a result of a determination regarding a validity of the qualification information from a server apparatus by transmitting the qualification information of the identified user to the server apparatus; and a service providing unit that provides the service to the user when the qualification information is valid.

According to a third aspect of the present invention, there is provided a control method of an authentication terminal, the control method including: receiving a user information notification including first biometric information and qualification information from a terminal that stores the first biometric information of a user and the qualification information on a qualification required to receive a service; acquiring second biometric information of the user when the authentication terminal provides the service to the user; identifying the user to be provided the service by a matching processing using the acquired second biometric information and the first biometric information included in the user information notification and receiving a result of a determination regarding a validity of the qualification information from a server apparatus by transmitting the qualification information of the identified user to the server apparatus; and providing the service to the user when the qualification information is valid.

According to a fourth aspect of the present invention, there is provided a computer-readable storage medium, storing a program causing a computer mounted on an authentication terminal to perform processing for: receiving a user information notification including first biometric information and qualification information from a terminal that stores the first biometric information of a user and the qualification information on a qualification required to receive a service; acquiring second biometric information of the user when the authentication terminal provides the service to the user; identifying the user to be provided the service by a matching processing using the acquired second biometric information and the first biometric information included in the user information notification and receiving a result of a determination regarding a validity of the qualification information from a server apparatus by transmitting the qualification information of the identified user to the server apparatus; and providing the service to the user when the qualification information is valid.

### Advantageous Effects of Invention

The individual aspects of the present invention provide a system, an authentication terminal, a control method of an authentication terminal, and a storage medium that contribute to achieving a more secure authentication system. The advantageous effects of the present invention are not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a diagram illustrating an example of a schematic configuration of an information processing system according to a first example embodiment.

FIG. 3 is a diagram illustrating an operation of the information processing system according to the first example embodiment.

FIG. 4 is a diagram illustrating an operation of the information processing system according to the first example embodiment.

FIG. 5 is a diagram illustrating an operation of the information processing system according to the first example embodiment.

FIG. 6 is a diagram illustrating an operation of the information processing system according to the first example embodiment.

FIG. 7 is a diagram illustrating an operation of the information processing system according to the first example embodiment.

FIG. 8 is a diagram illustrating an example of a processing configuration of a server apparatus according to the first example embodiment.

FIG. 9 is a diagram illustrating an example of a display of a terminal according to the first example embodiment.

FIG. 10 is a diagram illustrating an example of a membership information database according to the first example embodiment.

FIG. 11 is a diagram illustrating an example of a display of the terminal according to the first example embodiment.

FIG. 12 is a diagram illustrating an example of a display of the terminal according to the first example embodiment.

FIG. 13 is a diagram illustrating an example of a display of the terminal according to the first example embodiment.

FIG. 14 is a diagram illustrating an example of a processing configuration of an identity verification server according to the first example embodiment.

FIG. 15 illustrates an example of a processing configuration of an authentication terminal according to the first example embodiment.

FIG. 16 is a diagram illustrating an example of a user information database according to the first example embodiment.

FIG. 17 is a flowchart illustrating an example of an operation of the authentication terminal according to the first example embodiment.

FIG. 18 is a diagram illustrating an example of a processing configuration of the terminal according to the first example embodiment.

FIG. 19 is a sequence diagram illustrating an example of an operation of the information processing system according to the first example embodiment.

FIG. 20 is a diagram illustrating an example of a display of the terminal according to the first example embodiment.

FIG. 21 is a sequence diagram illustrating an example of an operation in the information processing system according to a variation 4 of the first example embodiment.

FIG. 22 is a diagram illustrating an example of a hardware configuration of a server apparatus according to the present application.

FIG. 23 is a diagram illustrating an example of a display of a terminal according to a variation in the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

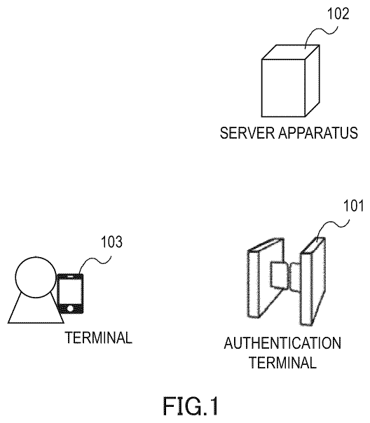

A system according to an example embodiment includes an authentication terminal 101, a server apparatus 102, and a terminal 103 (see FIG. 1). The terminal 103 stores first biometric information of a user and qualification information on a qualification required to receive a service from the authentication terminal 101. When the terminal 103 is ready to communicate with the authentication terminal 101, the terminal 103 transmits a user information notification including the first biometric information and the qualification information to the authentication terminal 101. When the authentication terminal 101 provides the service to the user, the authentication terminal 101 acquires second biometric information of the user and identifies the user to be provided the service by a matching processing using the acquired second biometric information and the first biometric information included in the user information notification. The authentication terminal 101 transmits the qualification information of the identified user to the server apparatus 102. The server apparatus 102 determines a validity of the qualification information and transmits a result of the determination to the authentication terminal 101. The authentication terminal 101 provides the service to the user when the qualification information is valid.

In the above system, the terminal 103 possessed by the user retains biometric information, which is personal information of the user. In other words, the server apparatus 102 does not retain the biometric information. Since the server apparatus 102 does not retain any biometric information, a highly secure system is provided.

Hereinafter, specific example embodiments will be described in more detail with reference to drawings.

### First Example Embodiment

A first example embodiment will be described in more detail with reference to drawings.

### [System Configuration]

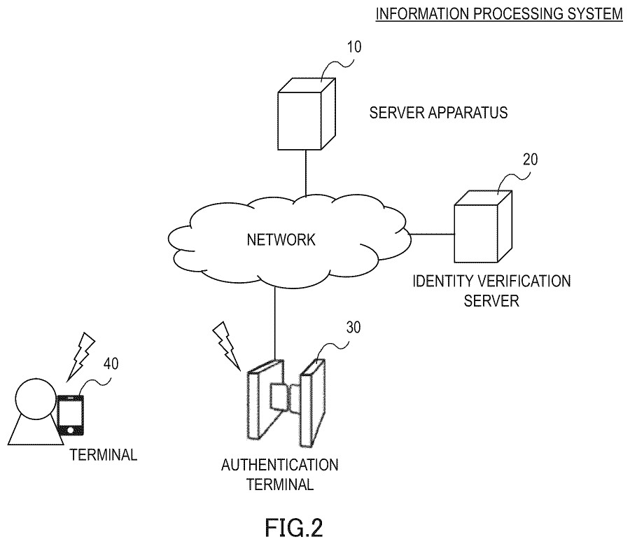

FIG. 2 is a diagram illustrating an example of a schematic configuration of an information processing system (an authentication system, an electronic ticketing system) according to the first example embodiment. As shown in FIG. 2, the information processing system includes a server apparatus 10, an identity verification server 20, an authentication terminal 30, and a terminal 40.

In the information processing system according to the first example embodiment, the terminal 40 of a user stores information on a qualification required to receive a service from the authentication terminal 30. The authentication terminal 30 provides the service to the user when the user has a required qualification to receive the service from the authentication terminal 30. For example, the authentication terminal 30 allows the user to pass through a gate when the user has purchased ticket for using transportation or ticket for entering event venue. Alternatively, the authentication terminal 30 allows the user who has a qualification to enter a workplace or school, such as an employee at the workplace or a student at the school, to pass through the gate.

In the first example embodiment, information on a qualification required to receive a service from the authentication terminal 30 is described as “qualification information”. Examples of the qualification information include ticket ID that identifies a ticket (legitimate or valid ticket) purchased by a user, employee number, student number, and so on. The first example embodiment will be described using an example of a case in which a user purchases a ticket. In other words, the ticket ID corresponds to the qualification information.

The server apparatus 10 is managed and operated by a ticket sales operator or the like. An example of a ticket sold by the operator is the ticket related to transportation such as an airplane, train, or ship, or ticket related to an event such as sporting event, concert, theater, or movie. Alternatively, the ticket sold by the above operator may be a ticket for admission to amusement park, and so on, or a ticket for an attraction, and so on, installed at the amusement park. In the first example embodiment, it will be explained by taking as an example a train or bus ticket, in particular, a tour ticket (free pass) that allows an unlimited use of the train, and so on, within a predetermined area within a predetermined period of time.

The server apparatus 10 is an apparatus responsible for membership registration of users who purchase ticket, ticket sales, and so on. The server apparatus 10 may be installed in a building of the ticket sales operator or may be installed on a network (on a cloud). The server apparatus 10 sells ticket (electronic ticket) to member.

The identity verification server 20 is a server that provides an online identity verification service. The identity verification server 20 provides the identity verification service not only to a ticket sales operator, but also to wide range of industries, such as financial institution, government agency, and so on. The identity verification server 20 provides an eKYC (electronic Know Your Customer) service.

The authentication terminal 30 is, for example, an apparatus (gate apparatus having a gate) installed at entrance or exit of an area that does not allow entry unless a valid ticket is in possession. The authentication terminal 30 allows a user who has the valid ticket to pass (enter the above area) and refuses to allow the user who does not have the valid ticket to pass. For example, the authentication terminal 30 is a ticket gate installed at a station.

In this way, the authentication terminal 30 according to the first example embodiment provides a user with a service related to gate opening and closing. In other words, the authentication terminal 30 according to the first example embodiment allows the user with valid qualification to pass through the gate and allows the user to receive predetermined service (for example, using transportation service). Note that the authentication terminal 30 of the present application may provide other services. For example, the authentication terminal 30 may also provide the service related to issuing a ticket or checking baggage. That is, the system of the present application may include the authentication terminal 30 that provides a check-in service or the like.

As shown in FIG. 2, a user has the terminal 40. For example, the terminal 40 is a mobile terminal, such as a smartphone or tablet.

The apparatuses illustrated in FIG. 2 are connected to each other. Specifically, the server apparatus 10, the identity verification server 20, and the authentication terminal 30 are each connected by wired or wireless communication means so that the server apparatus 10, the identity verification server 20, and the authentication terminal 30 can communicate with each other. Furthermore, the terminal 40 is configured to be able to communicate with the server apparatus 10, and so on via a mobile line. Furthermore, the terminal 40 is configured to be able to communicate with the authentication terminal 30 by means of short-range wireless communication such as Bluetooth (registered trademark).

A configuration of the information processing system shown in FIG. 2 is an example and is not intended to limit the configuration. For example, the information processing system may include a plurality of server apparatuses 10. The information processing system may include at least one or more authentication terminals 30. Note that in the drawings, including FIG. 2, the authentication terminal 30 is shown as a gate apparatus that has a gate.

### [Outline of Operation]

Next, operations of the information processing system according to the first example embodiment will be described.

### <Membership Registration>

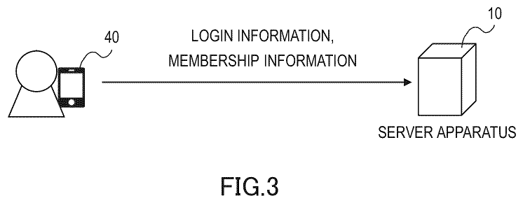

A user who wishes to purchase a ticket (tour ticket or free pass) sold by a ticket sales operator is required to make a membership registration with the operator (see FIG. 3).

Specifically, the user operates the terminal 40 to access the server apparatus 10, determines login information (for example, user ID and password), and inputs information such as name and date of birth (hereinafter referred to as “membership information”) into the server apparatus 10.

The server apparatus 10 registers the login and membership information acquired from the user in a membership information database. Details of the membership information database are described below.

### <Application for Use of Biometric Authentication>

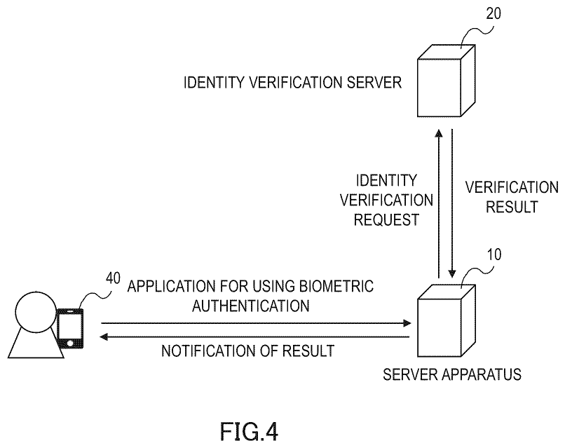

Here, a user who has purchased a ticket can receive a service using a biometric authentication (authentication using biometric information) from the authentication terminal 30. Specifically, the user can pass through a gate of the authentication terminal 30 by biometric authentication. In order to pass through the gate of the authentication terminal 30 using biometric authentication, a prior application is required (see FIG. 4).

Examples of the biometric information include data (feature values) calculated from physical features unique to this individual, such as a face, a fingerprint, a voiceprint, a vein, a retina, or an iris pattern of an eye of the user. Alternatively, the biometric information may be image data of a face image or a fingerprint image of the user, for example. The biometric information may be any information including physical features of a user. The present application describes a case in which biometric information (a face image or a feature value generated from the face image) regarding a “face” of a person is used.

For example, a user operates the terminal 40 to login to a portal site provided by the server apparatus 10. The user submits an “application for using biometric authentication” on the portal site. When the server apparatus 10 receives the application, the server apparatus 10 requests the identity verification server 20 to verify an identity of the user.

Specifically, the server apparatus 10 acquires biometric information (for example, face image) that the user has applied for as biometric information to be used in the biometric authentication and a copy of an identity verification document (for example, driver's license or passport with face image described on the document). The server apparatus 10 transmits an “identity verification request” that includes the acquired biometric information and the identity verification document to the identity verification server 20.

In the following descriptions, biometric information (face image) that a user has applied for as biometric information to be used in biometric authentication is described as “biometric information for application (face image for application)”. Alternatively, biometric information for application (face image for application) can be regarded as biometric information (face image) prepared for biometric authentication.

The identity verification server 20 performs an authentication processing (one-to-one authentication) using the acquired face image and the face image described on the identity verification document, and when the authentication is successful, the identity verification server 20 determines that the identity verification is successful. The identity verification server 20 also acquires personal information described in the identity verification document (for example, name, date of birth, and so on) and transmits the personal information along with a verification result (identity verification success or identity verification failure) to the server apparatus 10.

The server apparatus 10 permits an “application for using biometric authentication” if the verification result acquired from the identity verification server 20 is “identity verification successful” and if the personal authentication information acquired from the user matches membership information acquired from the user in advance. On the other hand, the server apparatus 10 rejects the “application for using biometric authentication” if the verification result is “identity verification failure” or if the acquired personal information does not match the membership information acquired from the user in advance.

The server apparatus 10 notifies the terminal 40 of a verification result of the application for using biometric authentication. When the application for using biometric authentication is permitted, the terminal 40 stores the biometric information for application as “biometric information for authentication”. At that time, the terminal 40 may generate a feature value from the face image for application and store the generated feature value as the “biometric information for authentication”.

When the application for using biometric authentication is rejected, the terminal 40 notifies the user that the application for using biometric authentication has been rejected.

### <Purchase Ticket>

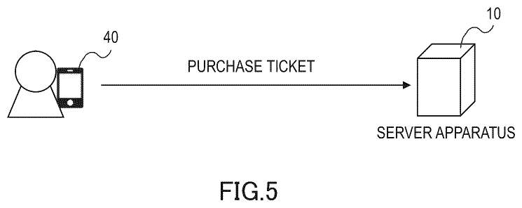

The user who has completed the membership registration can purchase a ticket (see FIG. 5). For example, the user operates the terminal 40 to login to a portal site provided by the server apparatus 10. The user moves to a ticket purchase page from the portal site and purchases a ticket.

The server apparatus 10 registers information on the purchased ticket (for example, type of the purchased ticket) in the membership information database.

### <Validation of Ticket>

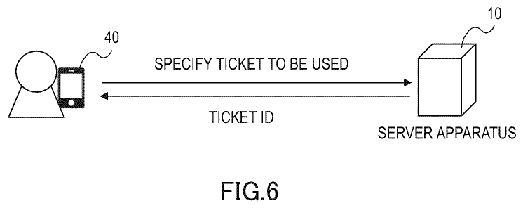

A user who has purchased a ticket is required to validate the ticket when the user uses the ticket (see FIG. 6). For example, when a user purchases a one-day tour ticket that allows the user to use a train, and so on, as many times as he or she wishes in one day, the user is required to validate the ticket (one-day tour ticket) just before entering a station with the one-day tour ticket.

For example, the user operates the terminal 40 to login to a portal site provided by the server apparatus 10. The user selects a ticket that he or she wishes to use from a list of tickets to be purchased on the portal site.

When a ticket is selected, the server apparatus 10 generates ticket ID to identify the selected ticket. The server apparatus 10 notifies the terminal 40 of the generated ticket ID.

The terminal 40 stores the notified ticket ID.

### <Use of Ticket>

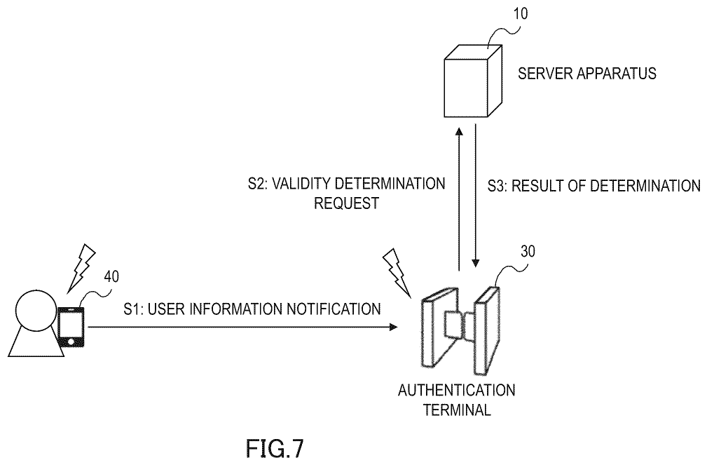

When the ticket is validated, a user approaches the authentication terminal 30 with the terminal 40 in his or her possession (see FIG. 7). When a distance between the terminal 40 and the authentication terminal 30 reaches a predetermined distance (a distance where communication by short-range wireless communication is possible; for example, about 10 meters), the terminal 40 transmits a “user information notification” to the authentication terminal 30 (step S1).

The user information notification includes biometric information that has been applied for using and approved for application in advance (biometric information for authentication) and ticket ID for the ticket that has been validated.

The authentication terminal 30 stores the biometric information for authentication and the ticket ID included in the user information notification in a user information database. Details of the user information database are described below.

When the user approaches the authentication terminal 30 further, the authentication terminal 30 photographs the user and acquires his or her face image (biometric information). The authentication terminal 30 performs matching processing (1-to-N matching, where N is a positive integer) using the acquired biometric information and the biometric information for authentication stored in the user information database and identifies the user who has arrived at the authentication terminal 30.

The authentication terminal 30 transmits a “validity determination request” to the server apparatus 10 that includes the ticket ID of the identified user (step S2).

The server apparatus 10 identifies the ticket from the ticket ID included in the validity determination request and determines a validity of the ticket. The server apparatus 10 transmits a result of the determination (valid ticket, invalid ticket) to the authentication terminal 30 (step S3).

When the ticket is determined to be valid, the authentication terminal 30 provides a service to the user. Specifically, the authentication terminal 30 according to the first example embodiment opens a gate and allows the user to pass. When ticket is determined to be invalid, the authentication terminal 30 refuses to provide the service to the user. Specifically, the authentication terminal 30 according to the first example embodiment closes the gate and refuses the user to pass.

Next, details of the individual apparatuses included in the information processing system according to the first example embodiment will be described.

### [Server Apparatus]

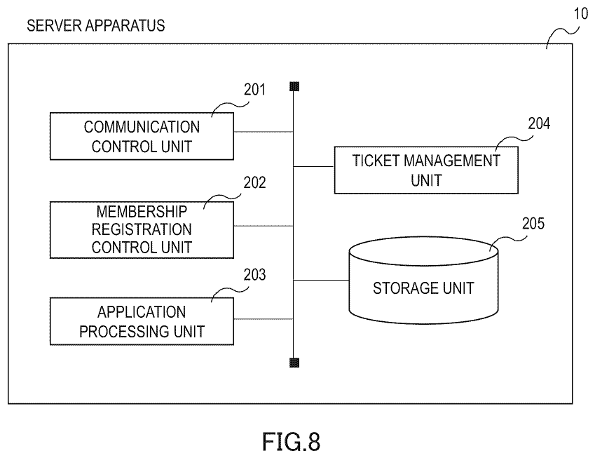

FIG. 8 is a diagram for illustrating an example of a processing configuration (processing modules) of the server apparatus 10 according to the first example embodiment. As illustrated in FIG. 8, the server apparatus 10 includes a communication control unit 201, a membership registration control unit 202, an application processing unit 203, a ticket management unit 204, and a storage unit 205.

The communication control unit 201 is means for controlling communication with other apparatuses. For example, the communication control unit 201 receives data (packets) from the authentication terminal 30. In addition, the communication control unit 201 transmits data to the authentication terminal 30. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data toward other apparatuses.

The membership registration control unit 202 is means for realizing membership registration for a user. The membership registration control unit 202 displays a GUI and so on for the membership registration on the terminal 40 when the terminal 40 accesses a predetermined home page.

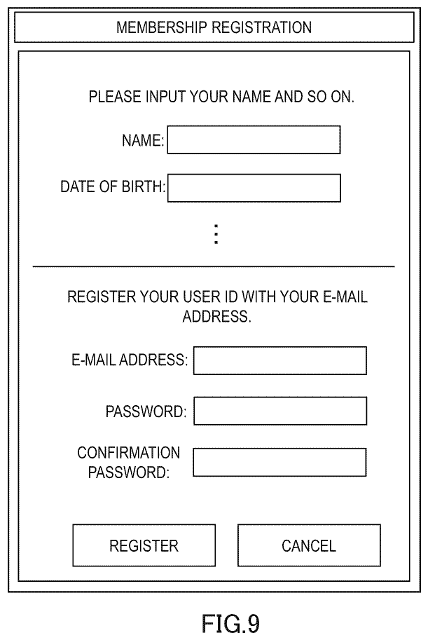

For example, the membership registration control unit 202 displays a GUI as shown in FIG. 9. The membership registration control unit 202 acquires membership information such as name, date of birth, and so on, and login information (user ID and password) to login to a portal site through the GUI as shown in FIG. 9. In the example in FIG. 9, the membership registration control unit 202 acquires an e-mail address as the user ID.

The membership registration control unit 202 performs a verification using the acquired e-mail address (so-called e-mail address authentication). For example, the membership registration control unit 202 transmits an e-mail that includes URL (Uniform Resource Locator) for the verification to the acquired e-mail address. When the user clicks on the URL, the membership registration control unit 202 detects the click and determines that the e-mail address authentication has been succeeded. When the membership registration control unit 202 cannot detect the click (access to the link) within a predetermined period of time, the membership registration control unit 202 determines that a non-existent or incorrect e-mail address was input and that the e-mail address authentication has failed.

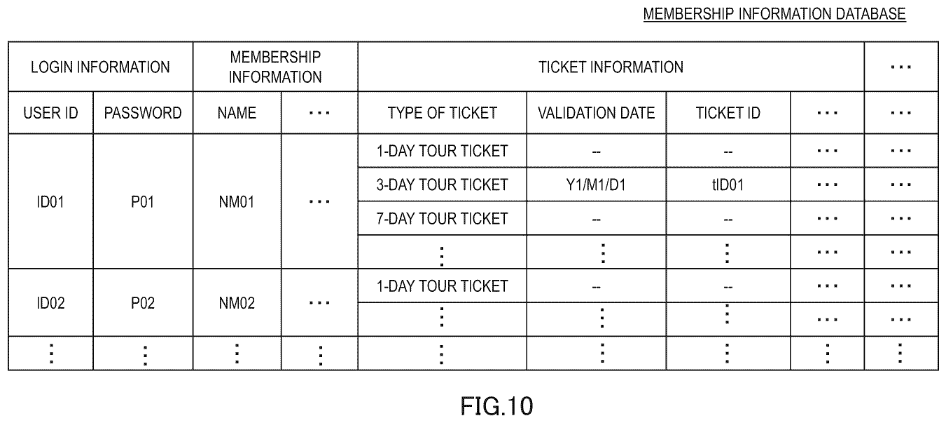

When the e-mail address authentication is successfully completed, the membership registration control unit 202 stores the login information (user ID and password) and the membership information (name, date of birth, and so on) in the membership information database (see FIG. 10). As shown in FIG. 10, the membership information database includes a login information field, a membership information field, and a ticket information field, and so on. As shown in FIG. 10, biometric information of a user (for example, a face image and a feature value generated from the face image) is not registered in the membership information database. Note that the membership information database shown in FIG. 10 is an example and is not intended to limit items to be stored.

Here, at the timing when the user registration control unit 202 registers the user as a member, the user has not purchased a ticket, so nothing is set in the ticket information field.

The application processing unit 203 is means for processing an application for using biometric authentication by a user. For example, when a user operates the terminal 40 and selects a predetermined menu on the portal site (for example, a menu for using face authentication), the application processing unit 203 performs a procedure for the user to apply for using biometric authentication.

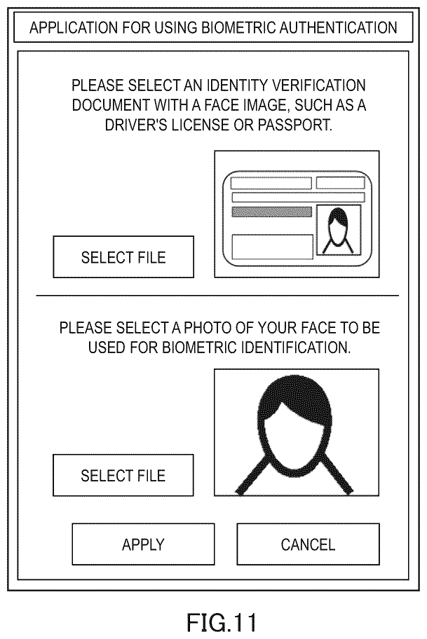

For example, the application processing unit 203 uses a GUI to acquire biometric information for application and a copy of an identity verification document. For example, the application processing unit 203 uses a GUI shown FIG. 11 to acquire the biometric information for application and the copy of the identity verification document. Alternatively, the application processing unit 203 may instruct the user to operate the terminal 40 to photograph his or her face and the identity verification document. Note that, as shown in FIG. 11, the copy of the identity verification document (image file) and biometric information for application (face image file) selected by the user are displayed on the terminal 40. The face image selected by the user is the “biometric information for application”.

The application processing unit 203 transmits an “identity verification request” including the acquired biometric information (biometric information for application) and the copy of the identity verification document to the identity verification server 20.

The application processing unit 203 acquires a verification result (identity verification success or identity verification failure) from the identity verification server 20.

When the application processing unit 203 acquires an identity verification success, the application processing unit 203 searches the membership information database using the user ID (e-mail address input at the time of login) of the user as a key, and identifies a corresponding entry. The application processing unit 203 compares the membership information of the identified entry with personal information acquired from the identity verification server 20.

If corresponding items of the membership information and the personal information (for example, name and date of birth) match, the application processing unit 203 permits the application for using biometric authentication for the user. If the corresponding items of the membership information and the personal information (for example, name and date of birth) do not match, the application processing unit 203 rejects the application for using biometric authentication for the user. In this way, the application processing unit 203 compares the membership information registered in advance by the user with the personal information acquired from the identity verification server 20 (personal information described in the identity verification document), and determines the application for using biometric authentication by the user.

If the application processing unit 203 acquires an identity verification failure from the identity verification server 20, the application processing unit 203 rejects the application for using biometric authentication by the user.

The application processing unit 203 notifies the terminal 40 of a response (verification result) to the application for using biometric authentication from the user. Specifically, the application processing unit 203 notifies the terminal 40 of a permission of the application for using biometric authentication or a rejection of the application for using biometric authentication.

The ticket management unit 204 is means for controlling and managing a ticket that is purchased by a user. For example, the ticket management unit 204 performs control when the user purchases a ticket. Specifically, when the user operates the terminal 40 and selects a predetermined menu on a portal site (for example, ticket purchase menu), the ticket management unit 204 displays a list of tickets that the user can purchase.

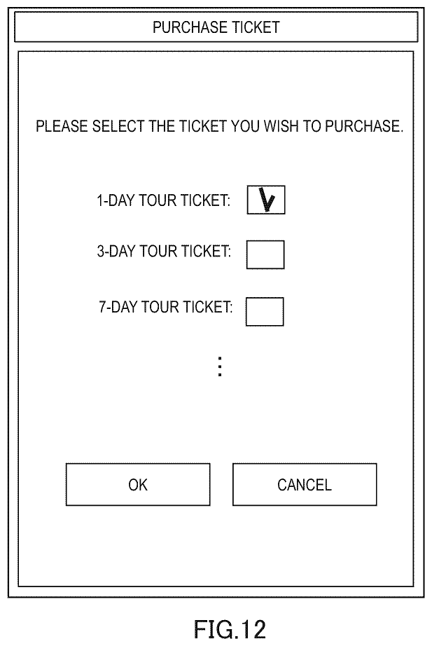

For example, the ticket management unit 204 displays a GUI as shown in FIG. 12 on the terminal 40. The ticket management unit 204 registers information on the ticket purchased by the user in the membership information database.

Specifically, the ticket management unit 204 registers a type of the ticket purchased by the user (for example, 1-day tour ticket, 3-day tour ticket, and so on) in the membership information database.

Note that a detailed description of a settlement for the purchased tickets is omitted. The server apparatus 10 may settle the purchase ticket by means such as payment using a credit card or bank transfer.

In addition, the ticket management unit 204 performs control regarding validating the ticket purchased by a user. Specifically, when the user operates the terminal 40 and selects a predetermined menu on a portal site (for example, ticket validation menu), the ticket management unit 204 displays a list regarding the tickets that the user has already purchased.

The ticket management unit 204 searches the membership information database using a user ID (e-mail address input at the time of login) of the user as a key and identify the user. The ticket management unit 204 acquires a type of the ticket that the user has already purchased from a ticket information field (ticket type field) of the identified user (entry).

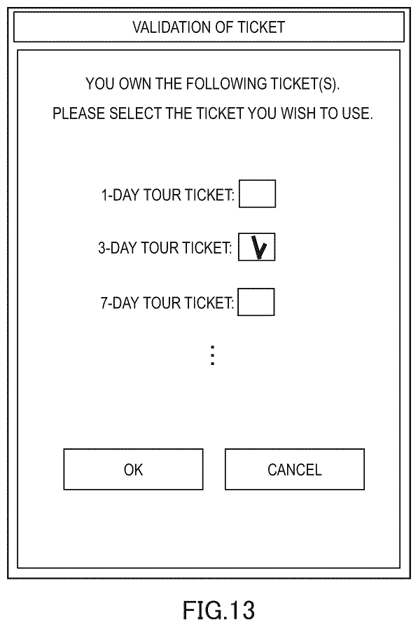

The ticket management unit 204 displays a list of the acquired types of the tickets and displays a GUI that allows the user to select a ticket that he or she wishes to use from among the purchased tickets. For example, the ticket management unit 204 displays a GUI as shown in FIG. 13 and acquires the type of ticket that the user wishes to use.

The ticket management unit 204 sets a validation date (date of use; today's date) in a validation date field for the type of the acquired ticket.

After that, the ticket management unit 204 generates ticket ID that uniquely identifies the ticket (validated ticket) to be used by the user. For example, the ticket management unit 204 generates the ticket ID by calculating a hash value from a concatenated value of the user ID of the user, the current date and time, and the type of the ticket. Alternatively, the ticket management unit 204 may number the ticket ID each time the ticket is validated.

The ticket management unit 204 writes the generated ticket ID into a ticket ID field in the membership information database. After that, the ticket management unit 204 transmits the generated ticket ID to the terminal 40. In this way, the ticket management unit 204 generates the ticket ID and transmits the generated ticket ID to the terminal 40 when the user indicates his or her intention to use the sold ticket.

In addition, the ticket management unit 204 processes a “validity determination request” received from the authentication terminal 30. The ticket management unit 204 searches the membership information database using the ticket ID included in the validity determination request as a key and identifies a corresponding entry.

The ticket management unit 204 determines whether the ticket to be used by the user is valid or not based on a type of the ticket and validation date of the identified entry. For example, when the ticket is a “one-day tour ticket”, if a processing date of the validity determination request and the validation date match (if the ticket is used on the same day), the ticket management unit 204 determines that the ticket is valid. Similarly, when the ticket is a “3-day tour ticket”, the ticket management unit 204 determines that the ticket is valid if the processing date of the validity determination request is within 3 days of the validation date. In other words, if the processing date of the validity determination request is four days after the validation date, the ticket management unit 204 determines that the ticket is invalid.

In this way, when the ticket sold to the user is a tour ticket for transportation, the ticket management unit 204 determines the validity of the ticket ID based on the type of the tour ticket and the date and time when the user indicated his or her intention to use the ticket.

The ticket management unit 204 notifies the authentication terminal 30 of a result of the determination (valid ticket or invalid ticket).

The storage unit 205 is means for storing information necessary for an operation of the server apparatus 10. The membership information database is established in the storage unit 205.

### [Identity Verification Server]

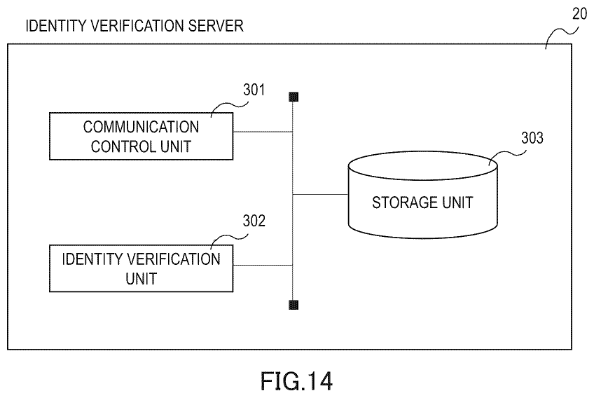

FIG. 14 is a diagram illustrating an example of a processing configuration (processing modules) of the identity verification server 20 according to the first example embodiment. As illustrated in FIG. 14, the identity verification server 20 includes a communication control unit 301, an identity verification unit 302, and a storage unit 303.

The communication control unit 301 is means for controlling communication with other apparatuses. Specifically, the communication control unit 301 receives data (packets) from the server apparatus 10. In addition, the communication control unit 301 transmits data to the server apparatus 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The identity verification unit 302 is means for processing an identity verification request received from the server apparatus 10 and performing identity verification. The identity verification unit 302 generates a feature value from a face image (biometric information for application) that is included in the identity verification request.

An existing technique can be used to generation process of the feature value, and therefore, detailed description thereof will be omitted. For example, the identity verification unit 302 extracts the eyes, nose, mouth, etc. from the face image as the feature points. Next, the identity verification unit 302 calculates the location of an individual feature point and the distance between feature points as feature values and generates a feature vector formed by the plurality of feature values (vector information that characterizes the face image).

Similarly, the identity verification unit 302 generates a feature value from the face image described in the identity verification document.

The identity verification unit 302 performs an authentication processing (one-to-one authentication) using the two generated feature values above. Specifically, the identity verification unit 302 calculates a similarity between two feature values. For the individual similarity, the chi-squared distance, the Euclidean distance, or the like may be used. A longer distance represents a lower similarity, and a shorter distance represents a higher similarity.

If the similarity is greater than or equal to a predetermined value, the identity verification unit 302 determines that the identity verification (authentication) is successful. If the similarity is smaller than the predetermined value, the identity verification unit 302 determines that the identity verification has failed.

When the identity verification is successful, the identity verification unit 302 reads personal information (name, date of birth, and so on) from an identity verification document. Specifically, the identity verification unit 302 uses OCR (Optical Character Recognition) technology to read the name, date of birth, and so on from the identity verification document.

The identity verification unit 302 transmits a verification result (identity verification success or identity verification failure) to the server apparatus 10. When the identity verification unit 302 notifies the identity verification success, the identity verification unit 302 also transmits the personal information read from the above identity verification document to the server apparatus 10.

The storage unit 303 is means for storing information necessary for an operation of the identity verification server 20.

### [Authentication Terminal]

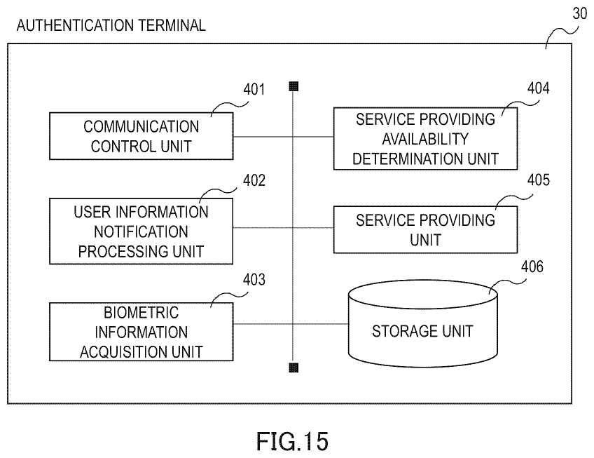

FIG. 15 is a diagram illustrating an example of a processing configuration (processing modules) of the authentication terminal 30 according to the first example embodiment. Referring to FIG. 15, the authentication terminal 30 includes a communication control unit 401, a user information notification processing unit 402, a biometric information acquisition unit 403, a service providing availability determination unit 404, a service providing unit 405, and a storage unit 406.

The communication control unit 401 is means for controlling communication with other apparatuses. For example, the communication control unit 401 receives data (packets) from the server apparatus 10. In addition, the communication control unit 401 transmits data to the server apparatus 10. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

In addition, the communication control unit 401 is compatible with short-range wireless communication such as Bluetooth (registered trademark) and communicates with the terminal 40 by means of the short-range wireless communication.

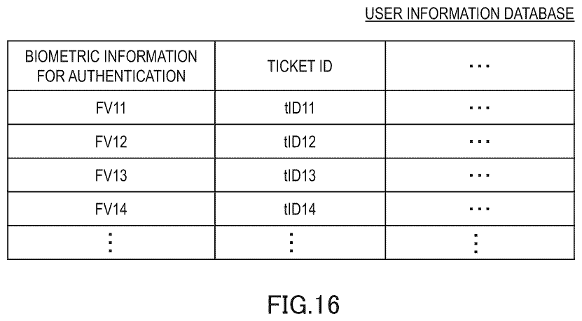

The user information notification processing unit 402 is means for processing a “user information notification” transmitted from the terminal 40. The user information notification processing unit 402 retrieves a feature value (biometric information for authentication) and ticket ID included in the user information notification. The user information notification processing unit 402 stores the retrieved feature value (biometric information for authentication) and the ticket ID in the user information database (see FIG. 16). The user information database is a database that stores information on a user who wishes to receive a service from the authentication terminal 30.

The biometric information acquisition unit 403 is means for controlling a camera device (camera device included in the authentication terminal 30) and acquiring biometric information (for example, a face image) of a user who has arrived at the authentication terminal 30 (a user who has arrived at a predetermined area in front of the authentication terminal 30). The biometric information acquisition unit 403 takes images of the front of own apparatus periodically or at predetermined times. The biometric information acquisition unit 403 determines whether the acquired image includes a human face image, and if the human face image is included, extracts the face image from the acquired image data.

An existing technique can be used for the face image detection and extraction processing performed by the biometric information acquisition unit 403, and therefore, detailed description thereof will be omitted. For example, the biometric information acquisition unit 403 may extract a face image (a face area) from the image data by using a learning model learned by a CNN (Convolutional Neural Network). Alternatively, the biometric information acquisition unit 403 may extract a face image by using a technique such as template matching.

The biometric information acquisition unit 403 generates a feature value from the extracted face image. The biometric information acquisition unit 403 hands over the generated feature value (biometric information) to the service providing availability determination unit 404.

The service providing availability determination unit 404 is means for determining whether or not to provide a service to a user who has arrived at the authentication terminal 30. For example, the service providing availability determination unit 404 determines whether or not to allow the user to pass through a gate. The service providing availability determination unit 404 performs matching processing using acquired biometric information and biometric information stored in the user information database (biometric information for authentication).

If the matching processing fails, the service providing availability determination unit 404 refuses to provide the service to the user (refuses to allow the user to pass through the gate). The service providing availability determination unit 404 sets the target person for determining whether or not to receive the service to “service cannot be provided”.

If the matching process is successful, the service providing availability determination unit 404 transmits a validity determination request that includes ticket ID of the entry identified by the matching processing to the server apparatus 10.

The service providing availability determination unit 404 acquires a result of the determination from the server apparatus 10. When the result of the determination is a “valid ticket”, the service providing availability determination unit 404 sets the target person for determining whether or not to receive the service to “service can be provided”. When the result of the determination is an “invalid ticket”, the service providing availability determination unit 404 sets the target person as “service cannot be provided.

The service providing availability determination unit 404 notifies the service providing unit 405 of the result of the service providing availability determination.

The service providing unit 405 is means for providing a service to a user. The service providing unit 405 of the authentication terminal 30 according to the first example embodiment controls a gate included in the authentication terminal 30. If a result of a service providing availability determination acquired from the service providing unit 404 is “service can be provided”, the service providing unit 405 provides a service (opens the gate and allows the user to pass through). If the result of the service providing availability determination acquired from the service providing availability determination unit 404 is “service cannot be provided”, the service providing unit 405 refuses to provide the service (closes the gate and refuses the user to pass through).

The storage unit 406 is means for storing information necessary for the operation of the authentication terminal 30. The user information database is established in the storage unit 406.

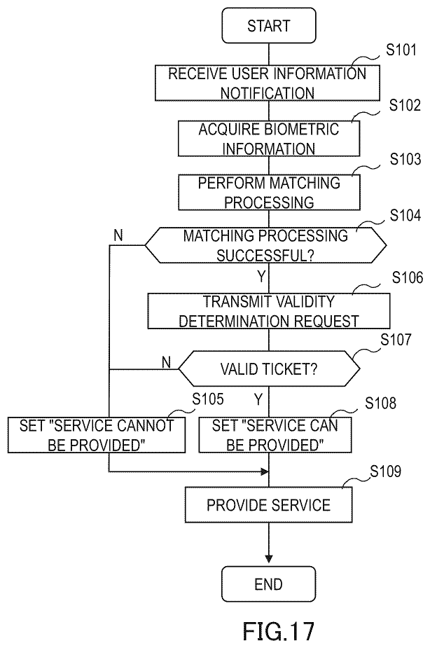

The operation of the authentication terminal 30 is summarized as a flowchart shown in FIG. 17. FIG. 17 is the flowchart illustrating an example embodiment of the operation of the authentication terminal 30 according to the first example embodiment.

The authentication terminal 30 receives a user information notification from the terminal 40 (step S101). The authentication terminal 30 registers biometric information (biometric information for authentication) and ticket ID included in the notification in the user information database.

The authentication terminal 30 acquires biometric information of a user who has arrived at own terminal (step S102).

The authentication terminal 30 performs matching processing using the acquired biometric information and the biometric information registered in the user information database (step S103).

When the matching processing fails (step S104, No branch), the authentication terminal 30 determines to refuse to provide a service to the user (set to “service cannot be provided”; step S105). Specifically, the authentication terminal 30 determines to refuse that the user passes through the gate.

When the matching processing is successful (step S104, Yes branch), the authentication terminal 30 transmits a validity determination request that includes ticket ID of the entry identified by the matching processing to the server apparatus 10 (step S106).

When a result of the determination is an “invalid ticket” (step S107, No branch), the authentication terminal 30 determines that the authentication terminal 30 refuses to provide the service to the user (set to “service cannot be provided”; step S105).

When a result of the determination is a “valid ticket” (step S107, Yes branch), the authentication terminal 30 determines that the authentication terminal 30 provides the service to the user (set to “service can be provided”; step S108).

The authentication terminal 30 provides a service based on the result of determining whether or not service can be provided (step S109). Specifically, when the result of determining whether or not service can be provided is “service can be provided” (when a user is allowed to pass through), the authentication terminal 30 opens the gate. When the result of determining whether or not service can be provided is “service cannot be provided” (when a user is refused to pass through), the authentication terminal 30 closes the gate.

In this way, the authentication terminal 30 acquires second biometric information of a user (a face image photographed by the camera device) when the authentication terminal 30 provides a service to the user. The authentication terminal 30 identifies the user who has arrived at the above authentication terminal 30 through matching processing using the acquired second biometric information and first biometric information (biometric information for authentication) included in a user information notification. The authentication terminal 30 transmits qualification information (ticket ID) of the identified user to the server apparatus 10. When the authentication terminal 30 acquires a result indicating that the qualification information is valid (a ticket corresponding to the ticket ID is valid) from the server apparatus 10, the authentication terminal 30 provides the service to the user (allows the user to pass through a gate).

### [Terminal]

Examples of the terminal 40 include a portable terminal apparatus such as a smartphone, a portable phone, a game console, or a tablet. The terminal 40 can be any equipment or device as long as the terminal 40 accepts user operations and can communicate with the server apparatus 10 and the authentication terminal 30.

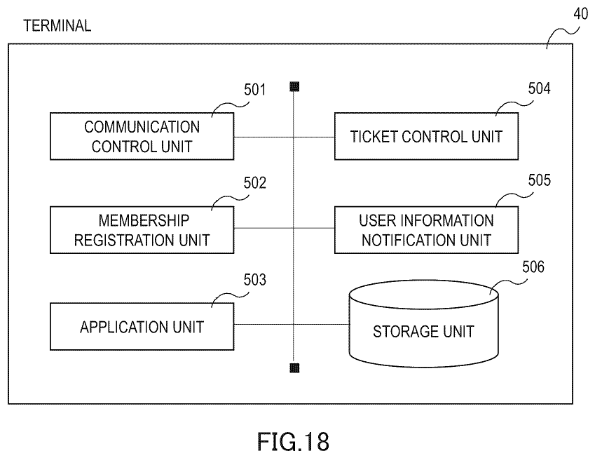

FIG. 18 is a diagram illustrating an example of a processing configuration (processing modules) of the terminal 40 according to the first example embodiment. Referring to FIG. 18, the terminal 40 includes a communication control unit 501, a membership registration unit 502, an application unit 503, a ticket control unit 504, a user information notification unit 505, and a storage unit 506.

Functions of the terminal 40 are realized by an application installed in the terminal. In other words, the membership registration unit 502, application unit 503, and so on are realized by the application.

The communication control unit 501 is means for controlling communication with other apparatuses. For example, the communication control unit 501 receives data (packets) from the server apparatus 10. In addition, the communication control unit 501 transmits data to the server apparatus 10. The communication control unit 501 gives data received from other apparatuses to other processing modules. The communication control unit 501 transmits data acquired from other processing modules to other apparatuses. In this way, other processing modules transmit and receive data to and from other apparatuses via the communication control unit 501. The communication control unit 501 includes a function as a receiving unit that receives data from other apparatuses and a function as a transmitting unit that transmits data to other apparatuses.

The communication control unit 501 is compatible with short-range wireless communication such as Bluetooth (registered trademark), and communicates with the authentication terminal 30 through the short-range wireless communication. When the communication control unit 501 completes a connection with the authentication terminal 30, the communication control unit 501 notifies the user information notification unit 505 to that effect. Note that it is assumed that a pairing process required when the terminal 40 and the authentication terminal 30 communicate via Bluetooth (registered trademark) has been completed in advance.

The membership registration unit 502 is means for realizing a membership registration of a user. The membership registration unit 502 accesses a predetermined website provided by the server apparatus 10 in response to an operation by the user. For example, the membership registration unit 502 acquires information shown in FIG. 9 and transmits the information to the server apparatus 10.

The application unit 503 is means for realizing an application for using biometric authentication. The application unit 503 accesses a predetermined website provided by the server apparatus 10 in response to an operation by a user. The application unit 503 acquires an identity verification document and biometric information for application as shown in FIG. 11. The application unit 503 transmits the acquired identity verification document and biometric information for application to the server apparatus 10.

The application unit 503 acquires a verification result regarding the application for using biometric authentication by the server apparatus 10. When the application for using biometric authentication is permitted, the application 503 stores the biometric information submitted to the server apparatus 10 (biometric information for application) as “biometric information for authentication” in the storage unit 506. At that time, when the application unit 503 has submitted a face image to the server apparatus 10, the application unit 503 may generate a feature value from the face image and store the feature value as “biometric information for authentication”.

When the application for using biometric authentication is rejected, the application unit 503 notifies the user to that effect. Alternatively, the application unit 503 may prompt the user to submit a different identity verification document or biometric information (a face image).

In this way, the terminal 40 transmits third biometric information of a user (biometric information for application) and an identity verification document of the user to the server apparatus 10. The server apparatus 10 verifies an identity of the user using the third biometric information and fourth biometric information (a face image of a driver's license, and so on) described in the identity verification document (the server apparatus 10 requests an identity verification to the identity verification server 20), and notifies the terminal 40 of a result of the identity verification. When the identity verification is successful, the terminal 40 stores the third biometric information (biometric information for application) as first biometric information (biometric information for authentication) to be transmitted to the authentication terminal 30.

The ticket control unit 504 is means for controlling purchasing a ticket and validating the ticket. The ticket control unit 504 accesses a predetermined website provided by the server apparatus 10 in response to an operation by a user. The ticket control unit 504 acquires a ticket selected (purchased) by the user from a list of tickets that can be purchased as shown in FIG. 12. The ticket control unit 504 transmits the acquired information on the purchased ticket to the server apparatus 10.

In addition, the ticket control unit 504 acquires a ticket to be validated by the user from a list of tickets retained by the user, as shown in FIG. 13. The ticket control unit 504 transmits information on the ticket to be validated (for example, type of ticket) to the server apparatus 10.

After the ticket control unit 504 has transmitted the ticket to be validated (the ticket to be used) to the server apparatus 10, the ticket control unit 504 receives ticket ID of the validated ticket from the server apparatus 10. The ticket control unit 504 stores the received ticket ID in the storage unit 506.

The user information notification unit 505 is means for notifying the authentication terminal 30 of information of a user who intends to pass through a gate of the authentication terminal 30 using a ticket. When the terminal 40 and the authentication terminal 30 are ready for communication, the user information notification unit 505 transmits a user information notification that includes biometric information for authentication (first biometric information) and qualification information (ticket ID) to the authentication terminal 30.

When the terminal 40 and authentication terminal 30 are connected, the user information notification unit 505 reads biometric information (biometric information for authentication) stored in the storage unit 506 and the ticket ID of the ticket that has been validated. The user information notification unit 505 transmits the user information notification that includes the biometric information for authentication and the ticket ID that have been read out to the authentication terminal 30.

The storage unit 506 is means for storing information necessary for the operation of the terminal 40. The storage unit 506 stores biometric information for authentication (first biometric information) of the user and qualification information (ticket ID) required to pass through the authentication terminal 30.

### [System Operation]

Next, operations of the information processing system according to the first example embodiment will be described.

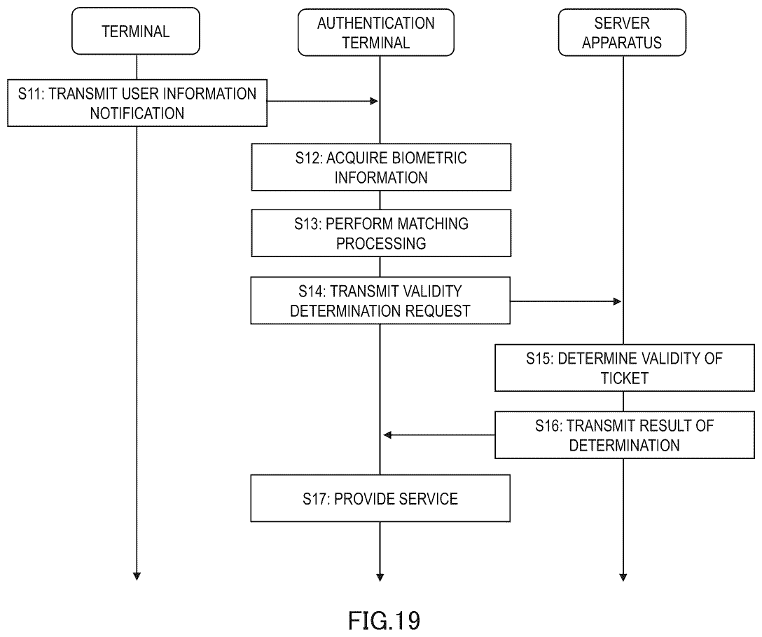

FIG. 19 is a sequence diagram illustrating an example of an operation in the information processing system according to the first example embodiment. Referring to FIG. 19, operations related to using a validated ticket will be described.

When a user approaches the authentication terminal 30, the terminal 40 transmits a user information notification that includes biometric information of the user and ticket ID to the authentication terminal 30 (step S11).

When the user arrives at the authentication terminal 30, the authentication terminal 30 acquires biometric information of the user (step S12).

The authentication terminal 30 performs a matching processing using the acquired biometric information and the biometric information acquired in the step S11, and identifies the user (person to be authenticated) who wishes to receive a service (performs a matching processing; step S13).

When the matching processing is successful, the authentication terminal 30 transmits a validity determination request that includes the ticket ID of the identified user to the server apparatus 10 (step S14).

The server apparatus 10 identifies a ticket that the user wishes to use based on the ticket ID and determines a validity of the ticket (step S15). The server apparatus 10 determines the validity of the ticket corresponding to the ticket ID (qualification information) and determines whether the user has purchased the ticket necessary for passing through the gate of the authentication terminal 30.

The server apparatus 10 transmits a result of the determination of the validity to the authentication terminal 30 (step S16).

The authentication terminal 30 provides the service based on the result of the received determination (step S17). For example, the authentication terminal 30 controls the gate based on the result of the received determination.

In this way, the server apparatus 10 sells a ticket to a user and transmits ticket ID of the sold ticket to the terminal 40. The terminal 40 transmits a user information notification to authentication terminal 30 including the ticket ID (ticket ID that identifies or proves a legitimate ticket to pass through the gate of the authentication terminal 30) as qualification information. The authentication terminal 30 transmits the ticket ID to the server apparatus 10. The server apparatus 10 determines a validity of the ticket ID (purchased ticket corresponding to the ticket ID) based on information of the sold ticket (type of ticket; for example, 1-day tour ticket, 3-day tour ticket) corresponding to the ticket ID.

### Variation 1 According to the First Example Embodiment

In the above first example embodiment, the operation of the information processing system (electronic ticketing system) is described by taking as an example a ticket that determines a timing at which a user uses the ticket. However, it is of course possible to apply the information processing system of the present application to a ticket for which period of availability (day of the week, time of day) is predetermined in advance.

For example, tickets for a concert or a sporting event are tickets for which the period of availability is predetermined. These tickets are used from before the start of the concert, and so on, until the end of the concert.

When such a ticket (ticket with a predetermined validity and usage period) is sold to a user, the server apparatus 10 (ticket management unit 204) generates ticket ID and transmits the ticket ID to the terminal 40 at the time of sale of the ticket. That is, the ticket ID is issued to the user (the terminal 40) at the time of purchasing the ticket, as shown in FIG. 5. The terminal 40 stores the ticket ID.

When the user arrives at a venue (or attempts to enter the venue), the terminal 40 transmits a user information notification that includes the above issued ticket ID and biometric information for authentication to the authentication terminal 30. The authentication terminal 30 transmits the ticket ID included in the received user information notification to the server apparatus 10 and requests the server apparatus 10 to determine a validity of the ticket.

The server apparatus 10 (the ticket management unit 204) identifies a ticket type corresponding to the ticket ID (for example, a ticket for a concert with a fixed date and time) and determines the validity of the ticket by the date and time, and so on, on which the ticket ID has been acquired.

The server apparatus 10 notifies the authentication terminal 30 of a result of the validity determination. The authentication terminal 30 controls a gate based on the result of the validity determination.

In this way, in some cases, depending on a type of ticket, the operation of the system related to “ticket validation” and the operation by a user may not be necessary. That is, unlike a ticket for transportation, a ticket for a concert or an event has a limited period of time during which the ticket can be used. Therefore, the server apparatus 10 can determine a validity of ticket ID according to whether or not the user has a ticket for the event, and so on, without performing a determination (determination regarding validity period of the ticket) using date and time when the ticket has been validated.

### Variation 2 According to the First Example Embodiment

The server apparatus 10 can also handle a different type of ticket. For example, the server apparatus 10 can also sell a ticket related to transportation, such as train or bus, and ticket related to an event, such as a concert, on the same portal site.

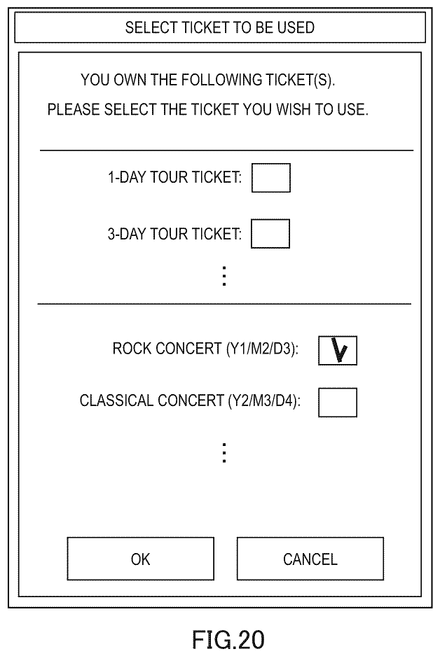

In such a case, the terminal 40 may identify a ticket to be used using a GUI that allows the user to select the ticket to be used. For example, the terminal 40 (the ticket control unit 504) may display a GUI as shown in FIG. 20 and acquire the ticket to be used by the user.

The terminal 40 (the user information notification unit 505) transmits ticket ID corresponding to the ticket selected by the user to the authentication terminal 30, along with biometric information for authentication.

Note that the ticket management unit 204 of the server apparatus 10 transmits a detail of sold ticket (name of the ticket and name of the corresponding event, and so on) and the ticket ID to the terminal 40 so that the terminal 40 can display in the manner shown in FIG. 20.

### Variation 3 According to the First Example Embodiment

When the server apparatus 10 handles a different type of ticket, it is assumed that a user may not be able to pass through the gate of the authentication terminal 30, even though the ticket itself is valid. For example, if a user validates a ticket for transportation, such as a one-day tour ticket, the user cannot enter a concert venue with the validated ticket. The authentication terminal 30 installed at the concert venue needs to block a passage of such a user.

Therefore, when the authentication terminal 30 transmits a validity determination request to the server apparatus 10, the authentication terminal 30 may transmit an authentication terminal ID along with ticket ID. The authentication terminal ID is an ID that identifies each authentication terminal 30 included in the system. A MAC (Media Access Control) address or an IP (Internet Protocol) address of the authentication terminal 30 may be used for the authentication terminal ID. The server apparatus 10 may use the authentication terminal ID to determine a location, such as where the authentication terminal 30, a sender of the validity determination request, is located, and determine a validity of the ticket based on the identified location and information on the ticket (validation date, and so on).

For example, when the server apparatus 10 receives ticket ID (valid ticket ID) corresponding to a “one-day tour ticket” from the authentication terminal 30 installed at a concert venue, the server apparatus 10 transmits an “invalid ticket” to the validity determination request from the authentication terminal 30. On the other hand, when the server apparatus 10 receives ticket ID corresponding to a concert ticket from the authentication terminal 30 installed at a concert venue, the server apparatus 10 processes the validity determination request from the authentication terminal 30 based on an opening time of the concert to be held at the concert venue, and so on.

### Variation 4 According to the First Example Embodiment

When the server apparatus 10 handles a different type of ticket, the authentication terminal 30 may instruct the terminal 40 to transmit ticket ID to the terminal 40, specifying a type of ticket to the terminal 40.

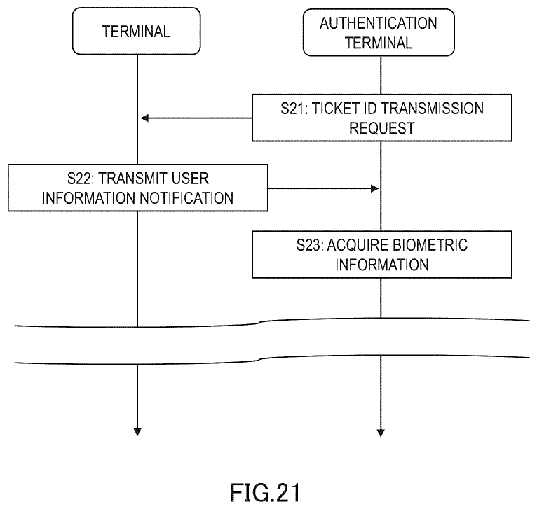

With reference to FIG. 21, operations of the information processing system in variation 4 according to the first example embodiment will be described.

When a user approaches the authentication terminal 30 (when the terminal 40 and the authentication terminal 30 start to communicate), the authentication terminal 30 specifies a type of ticket required for processing of own terminal (validity determination processing) and instructs the terminal 40 to transmit ticket ID of the specified type of ticket. Specifically, the authentication terminal 30 transmits a “ticket ID transmission request” to the terminal 40 that includes the type of ticket (step S21).

For example, the authentication terminal 30 installed at a ticket gate of a station instructs the terminal 40 to transmit ticket ID for a ticket related to the train. Similarly, the authentication terminal 30 installed at a concert venue instructs the terminal 40 to transmit ticket ID of a ticket related to the concert.

If ticket ID corresponding to the indicated type of ticket (ticket ID of a valid ticket) is stored, the terminal 40 transmits a user information notification that includes the ticket ID and biometric information for authentication to the authentication terminal 30 (step S22).

After that, when the user arrives at the authentication terminal 30, the authentication terminal 30 acquires biometric information of the user (Step 23). Detailed description of operations after step S23 is omitted since the operations can be the same as those of the system described using FIG. 19.

These operations eliminate the need for the user to select a ticket required to pass through the authentication terminal 30.

Note that in this case, the server apparatus 10 transmits a “ticket type ID” that identifies a type of ticket to the terminal 40 along with ticket ID. The terminal 40 stores the ticket type ID and the ticket ID in association with each other. In addition, a system administrator sets the ticket type ID for each authentication terminal 30, and the authentication terminal 30 instructs the terminal 40 to transmit the ticket ID corresponding to the ticket type ID.

As described above, in the information processing system (authentication system) according to the first example embodiment, biometric information of a user is stored inside the terminal 40 possessed by the user. In other words, neither the server apparatus 10 nor the authentication terminal 30 retains the biometric information of the user. As a result, a highly secure system is provided because personal information (biometric information) of the user is not leaked from the server apparatus 10 or the authentication terminal 30. Further, in the information providing system according to the first example embodiment, it is determined whether or not the user can receive a service from the authentication terminal 30 based on qualification information stored in the terminal 40 of the user. For example, ticket ID indicating a ticket purchased by the user, or an employee number or student ID number indicating that the user is an employee or student corresponds to the qualification information. The terminal 40 transmits biometric information and qualification information to the authentication terminal 30 in advance, before the user arrives at the authentication terminal 30. The authentication terminal 30 identifies the user who has arrived at own terminal by biometric authentication using the transmitted biometric information, and requests the server apparatus 10 to determine a validity determination for the corresponding qualification information. If the qualification information is valid, the authentication terminal 30 is notified of this fact, and the authentication terminal 30 provides a service to the user. In this way, processing related to biometric authentication and processing related to determining a validity of qualification information are shared by the authentication terminal 30 and the server apparatus 10, so that a load on each apparatus is reduced.

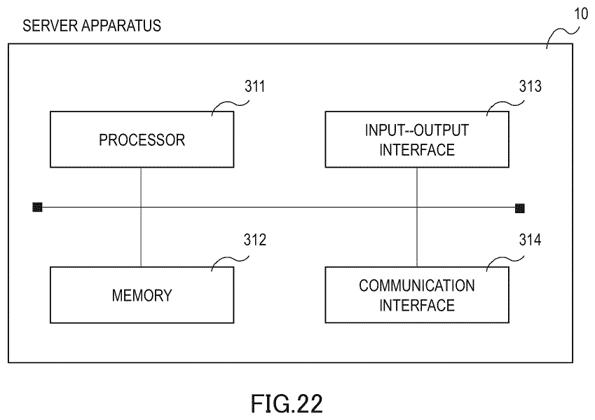

Next, a hardware configuration of an individual apparatus that constitutes the information processing system will be described. FIG. 22 is a diagram illustrating an example of a hardware configuration of the server apparatus 10.

The server apparatus 10 can be configured by an information processing apparatus (a so-called computer) and has a configuration illustrated as an example in FIG. 22. For example, the server apparatus 10 includes a processor 311, a memory 312, an input-output interface 313, a communication interface 314, and so on. The components such as the processor 311 are connected to an internal bus, and so on so that these components can communicate with each other.

The hardware configuration of the server apparatus 10 is not limited to the configuration illustrated in FIG. 22. The server apparatus 10 may include hardware not illustrated or may be configured without the input-output interface 313 if desired. In addition, the number of components, such as the number of processors 311, included in the server apparatus 10 is not limited to the example illustrated in FIG. 22. For example, a plurality of processors 311 may be included in the server apparatus 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display device and an input device not illustrated. For example, the display device is a liquid crystal display or the like. For example, the input device is a device, such as a keyboard or a mouse, which receives user operations.

The communication interface 314 is a circuit, a module, or the like for performing communication with other apparatuses. For example, the communication interface 314 includes a NIC (Network Interface Card) or the like.

The functions of the server apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the server apparatus 10, the authentication terminal 30 and so on can each be configured by an information processing apparatus, and the basic hardware configuration of the authentication terminal 30 is the same as that of the server apparatus 10. Thus, description of the basic hardware configuration of the authentication terminal 30 will be omitted. For example, the authentication terminal 30 may include a camera device for photographing a person to be authenticated or a gate.

The server apparatus 10, which is an information processing apparatus, includes a computer and can realize its functions by causing the computer to execute a program. In addition, the server apparatus 10 executes a control method of the server apparatus 10 by using this program. Similarly, the authentication terminal 30 includes a computer and can realize its functions by causing the computer to execute a program. In addition, the authentication terminal 30 executes a terminal control method by using this program.

### [Variations]

The configurations, operations, and so on of the information processing system according to the above example embodiment are examples and do not limit the present system configuration, and so on.

The above example embodiment describes that the server apparatus 10 manages membership information and ticket information using the membership information database. In addition to this information, the server apparatus 10 may manage a ticket usage history of a user using the membership information database. In other words, the server apparatus 10 may manage date and time when a validity determination request is processed, type of ticket, and so on, using the membership information database.

The server apparatus 10 may allow the system administrator (ticket sales operator) to check the ticket usage history and the like. Specifically, the server apparatus 10 may display a “check customer information” menu on a terminal, and so on, operated by the system administrator, and may display the ticket usage history and so on in response to a selection of the menu.

The information processing system may be capable of updating biometric information of a user (biometric information for authentication, face image). In this case, the server apparatus 10 acquires an identity verification document and a face image for updating from the terminal 40 when the user selects a predetermined menu (for example, updating a face image). The server apparatus 10 transmits the identity verification document and the face image for updating to the identity verification server 20 and requests an identity verification. If the identity verification is successful, the server apparatus 10 instructs the terminal 40 to use the face image for updating as “biometric information for authentication”.

When a user leaves from the electronic ticketing system, the server apparatus 10 deletes a corresponding entry in the membership information database. At that time, the server apparatus 10 may instruct the terminal 40 to delete biometric information for authentication.

The server apparatus 10 (the ticket management unit 204) may access the membership information database periodically or at a predetermined timing and delete entries for tickets that have become invalid or have passed those expiration date. For example, the server apparatus 10 may delete entries for tour tickets that have become invalid based on those validation date.

The above example embodiment describes a case in which a digitized ticket (electronic ticket) is subject to management, but the information processing system may also subject a paper ticket to management. For example, if ticket ID is written on a paper medium in format such as two-dimensional code, the server apparatus 10 and the terminal 40 may share the ticket ID using the two-dimensional code. For example, the terminal 40 photographs the two-dimensional code and registers the ticket ID acquired from the two-dimensional code in the server apparatus 10. When a user passes through the authentication terminal 30, the terminal 40 may transmit a user information notification that includes the ticket ID acquired from the two-dimensional code to the authentication terminal 30.

The above example embodiment describes a case when the server apparatus 10 requests the identity verification server 20 to verify an identity of a user. However, the server apparatus 10 may perform the identity verification. In other words, the server apparatus 10 may include the functions of the identity verification server 20. In this case, if a user is registered as a member, the server apparatus 10 stores membership information of the user. The server apparatus 10 performs a one-to-one matching using third biometric information (biometric information for application) of the user and fourth biometric information (face image for application described in a passport, and so on). The server apparatus 10 determines that the identity verification is successful when the one-to-one matching is successful and when personal information acquired from the identity verification document and membership information of the user registered in advance in the server apparatus 10 are matched.

The terminal 40 and the authentication terminal 30 may communicate with each other by means other than Bluetooth (registered trademark). For example, the terminal 40 and the authentication terminal 30 may communicate by ZigBee (registered trademark), NFC (Near Field Communication), and so on. Alternatively, the terminal 40 and the authentication terminal 30 may communicate by a standard compatible with a wireless LAN (Local Area Network).

The above example embodiment describes a case in which biometric information for authentication and ticket ID are stored in the terminal 40 possessed by the user. However, this information may be stored in other media. For example, the biometric information for authentication and the ticket ID may be stored inside a transportation IC (Integrated Circuit) card. In this case, a ticket corresponding to the ticket ID may be a commuter pass or the like.

In addition to the ticket ID, the terminal 40 may store other information necessary to receive a service from the authentication terminal 30. For example, if a “vaccination certificate” or “negative certificate” is required to receive the service from the authentication terminal 30, the terminal 40 stores these information internally. The terminal 40 transmits the vaccination certificate and the like along with the ticket ID to the authentication terminal 30. The authentication terminal 30 transmits the vaccination certificate to the server apparatus 10 or another external server and makes a validity determination request. The authentication terminal 30 may provide a service to the user (may allow the user to pass through a gate) when a ticket is valid and the vaccination certificate is also valid.

In the above example embodiment, the configuration, operation, and so on of the information processing system are described, using ticket ID as an example of qualification information. However, qualification information is not limited to the ticket ID. For example, if the authentication terminal 30 is installed at an entry/exit of a workplace, an “employee number” corresponds to the qualification information. In this case, the terminal 40 possessed by a user (employee) stores the employee number, which is information on a qualification required to pass through the authentication terminal 30 (qualification as an employee recognized by a company). When the terminal 40 approaches the authentication terminal 30, the terminal 40 transmits the employee number and biometric information for authentication to the authentication terminal 30, and the authentication terminal 30 identifies the employee by biometric information and transmits the employee number to the server apparatus 10 that manages information of the employee. If the employee number is valid (if the corresponding employee is enrolled), the server apparatus 10 determines that the qualification information is valid and notifies the authentication terminal 30 of this fact.

In the above example embodiment, the authentication terminal 30 transmits ticket ID (qualification information) of a user who has arrived at own terminal to the server apparatus 10 when the user has arrived at the authentication terminal 30. However, the authentication terminal 30 may transmit the ticket ID to the server apparatus 10 before the user arrives at the authentication terminal 30 and acquire a result of a validity determination. The authentication terminal 30 may store biometric information in association with the result of the validity determination (ticket is valid or invalid) and determine whether or not to provide a service to a user at the timing when the user is identified by biometric authentication. In other words, before the authentication terminal 30 acquires the biometric information (face image) of the user who has arrived at own terminal (before performing biometric authentication), the authentication terminal 30 may transmit the ticket ID to the server apparatus 10 and acquire the result of the determination before the user arrives at the authentication terminal 30. These operations allow the authentication terminal 30 to provide a service (for example, controlling a gate) at substantially the same timing as the biometric authentication of the user is completed, thereby realizing increased throughput.

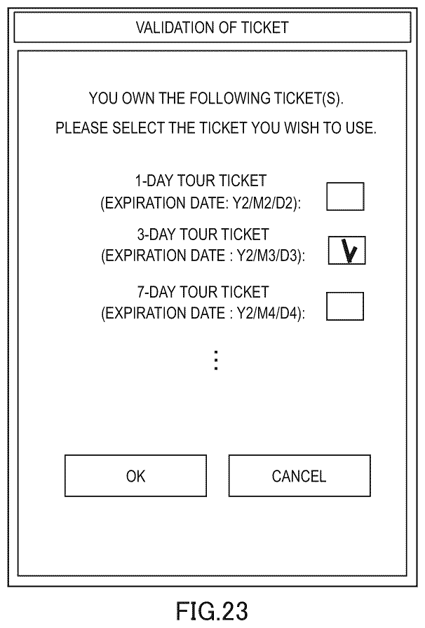

When a tour ticket purchased by a user has an expiration date set (for example, when the tour ticket is to be used within one year from the date of purchase), the terminal 40 may display the date of expiration for each tour ticket when the user purchases the ticket or validates the ticket. For example, as shown in FIG. 23, the terminal 40 may display a GUI that allows the user to select the ticket to be used, while displaying the date of expiration of the ticket purchased by the user. In this case, the server apparatus 10 manages the date of expiration of the tour ticket purchased by the user using the membership information database. Note that when the terminal 40 validates the ticket (selects the ticket to be used), the terminal 40 may also display information on the ticket that has already been used.

While the above example embodiment has been described based on a case in which the membership information database is established in the server apparatus 10, the membership information database may be established in an externally installed database server. That is, some functions of the server apparatus 10 may be implemented in another server. More specifically, the “application processing unit (application processing means)” and “ticket management unit (ticket management means)”, and so on, described above may be implemented in any of the apparatuses included in the system.

While the data transmitted and received between each apparatus (the server apparatus 10, the identity verification server 20, the authentication terminal 30, and the terminal 40) is not limited to any particular mode, the data transmitted and received between these apparatuses may be encrypted. It is desirable that biometric information, personal information and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiment ha s been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system that sells tickets to users.

A part or the entirety of the example embodiment described above may be described as in the following supplementary notes, but is not limited to the followings.

### [Supplementary Note 1]

A system, including:
an authentication terminal;
a server apparatus; and
a terminal that stores first biometric information of a user and qualification information on a qualification required to receive a service from the authentication terminal,
wherein the terminal transmits a user information notification including the first biometric information and the qualification information to the authentication terminal when the terminal is ready to communicate with the authentication terminal,
wherein the authentication terminal acquires second biometric information of the user when the authentication terminal provides the service to the user, identifies the user to be provided the service by a matching processing using the acquired second biometric information and the first biometric information included in the user information notification and transmits the qualification information of the identified user to the server apparatus,
wherein the server apparatus determines a validity of the qualification information and transmits a result of the determination to the authentication terminal, and
wherein the authentication terminal provides the service to the user when the qualification information is valid.

### [Supplementary Note 2]

The system according to supplementary note 1, wherein the terminal transmits third biometric information of the user and an identity verification document of the user to the server apparatus,
wherein the server apparatus verifies an identity of the user using the third biometric information and fourth biometric information described in the identity verification document and notifies the terminal of a result of the identity verification, and
wherein the terminal stores the third biometric information as the first biometric information to be transmitted to the authentication terminal when the identity verification is successful.

### [Supplementary Note 3]

The system according to supplementary note 1 or 2, wherein the server apparatus sells a ticket to the user and transmits a ticket ID of the sold ticket to the terminal,
wherein the terminal transmits the user information notification including the ticket ID as the qualification information to the authentication terminal 30,
wherein the authentication terminal transmits the ticket ID to the server apparatus, and
wherein the server apparatus determines a validity of the ticket ID based on information of the sold ticket corresponding to the ticket ID.

### [Supplementary Note 4]

The system according to supplementary note 3, wherein the server apparatus generates the ticket ID when the user indicates his or her intention to use the sold ticket, and transmits the generated ticket ID to the terminal.

### [Supplementary Note 5]

The system according to supplementary note 4, wherein the ticket sold to the user is a tour ticket for transportation.

### [Supplementary Note 6]

The system according to supplementary note 5, wherein the server apparatus determines the validity of the ticket ID based on a type of the tour ticket and a date and time when the user indicated his or her intention to use the ticket.

### [Supplementary Note 7]

The system according to supplementary note 2, wherein the server apparatus transmits the third biometric information and the identity verification document to an identity verification server that provides an eKYC (electronic Know Your Customer) service and requests the identity verification of the user to the identity verification server.

### [Supplementary Note 8]

The system according to supplementary note 2, wherein the server apparatus stores membership information of the user if the user is registered as a member, determines that the identity verification is successful when a one-to-one matching using the third biometric information and the fourth biometric information is successful and when personal information acquired from the identity verification document and the membership information of the user registered in advance in the server apparatus are matched.

### [Supplementary Note 9]

The system according to any one of supplementary notes 1 to 8, wherein the terminal communicates with the authentication terminal through a short-range wireless communication.

### [Supplementary Note 10]

The system according to any one of supplementary notes 1 to 9, wherein the terminal communicates with the authentication terminal via Bluetooth (registered trademark).

### [Supplementary Note 11]

The system according to any one of supplementary notes 1 to 10, wherein the biometric information is a face image or a feature value generated from the face image.

### [Supplementary Note 12]

An authentication terminal, including:
a receiving unit that receives a user information notification including first biometric information and qualification information from a terminal that stores the first biometric information of a user and the qualification information on a qualification required to receive a service;
a biometric information acquisition unit that acquires second biometric information of the user when the authentication terminal provides the service to the user;
a service providing availability determination unit that identifies the user to be provided the service by a matching processing using the acquired second biometric information and the first biometric information included in the user information notification and receives a result of a determination regarding a validity of the qualification information from a server apparatus by transmitting the qualification information of the identified user to the server apparatus; and
a service providing unit that provides the service to the user when the qualification information is valid.

### [Supplementary Note 13]

A control method of an authentication terminal, the control method including:
receiving a user information notification including first biometric information and qualification information from a terminal that stores the first biometric information of a user and the qualification information on a qualification required to receive a service;
acquiring second biometric information of the user when the authentication terminal provides the service to the user;
identifying the user to be provided the service by a matching processing using the acquired second biometric information and the first biometric information included in the user information notification and receiving a result of a determination regarding a validity of the qualification information from a server apparatus by transmitting the qualification information of the identified user to the server apparatus; and
providing the service to the user when the qualification information is valid.

### [Supplementary Note 14]

A computer-readable storage medium, storing a program causing a computer mounted on an authentication terminal to perform processing for:
receiving a user information notification including first biometric information and qualification information from a terminal that stores the first biometric information of a user and the qualification information on a qualification required to receive a service;
acquiring second biometric information of the user when the authentication terminal provides the service to the user;
identifying the user to be provided the service by a matching processing using the acquired second biometric information and the first biometric information included in the user information notification and receiving a result of a determination regarding a validity of the qualification information from a server apparatus by transmitting the qualification information of the identified user to the server apparatus; and
providing the service to the user when the qualification information is valid.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### REFERENCE SIGNS LIST

10 server apparatus
20 identity verification server
30 authentication terminal
40 terminal
101 authentication terminal
102 server apparatus
103 terminal
201 communication control unit
202 membership registration control unit
203 application processing unit
204 ticket management unit
205 storage unit
301 communication control unit
302 identity verification unit
303 storage unit
311 processor
312 memory
313 input-output interface
314 communication interface
401 communication control unit
402 user information notification processing unit
403 biometric information acquisition unit
404 service providing availability determination unit
405 service providing unit
406 storage unit
501 communication control unit
502 membership registration unit
503 application unit
504 ticket control unit
505 user information notification unit
506 storage unit

What is claimed is:

1. A system, comprising:
an authentication terminal;
a server apparatus; and
a terminal that stores first biometric information of a user and qualification information on a qualification required to receive a service from the authentication terminal,
wherein the terminal transmits a user information notification including the first biometric information and the qualification information to the authentication terminal when the terminal is ready to communicate with the authentication terminal,
wherein the authentication terminal acquires second biometric information of the user when the authentication terminal provides the service to the user, identifies the user to be provided the service by a matching processing using the acquired second biometric information and the first biometric information included in the user information notification and transmits the qualification information of the identified user to the server apparatus,
wherein the server apparatus determines a validity of the qualification information and transmits a result of the determination to the authentication terminal, and
wherein the authentication terminal provides the service to the user when the qualification information is valid.

2. The system according to claim 1, wherein the terminal transmits third biometric information of the user and an identity verification document of the user to the server apparatus,
wherein the server apparatus verifies an identity of the user using the third biometric information and fourth biometric information described in the identity verification document and notifies the terminal of a result of the identity verification, and
wherein the terminal stores the third biometric information as the first biometric information to be transmitted to the authentication terminal when the identity verification is successful.

3. The system according to claim 1, wherein the server apparatus sells a ticket to the user and transmits a ticket ID of the sold ticket to the terminal,
wherein the terminal transmits the user information notification including the ticket ID as the qualification information to the authentication terminal 30,
wherein the authentication terminal transmits the ticket ID to the server apparatus, and
wherein the server apparatus determines a validity of the ticket ID based on information of the sold ticket corresponding to the ticket ID.

4. The system according to claim 3, wherein the server apparatus generates the ticket ID when the user indicates his or her intention to use the sold ticket, and transmits the generated ticket ID to the terminal.

5. The system according to claim 4, wherein the ticket sold to the user is a tour ticket for transportation.

6. The system according to claim 5, wherein the server apparatus determines the validity of the ticket ID based on a type of the tour ticket and a date and time when the user indicated his or her intention to use the ticket.

7. The system according to claim 2, wherein the server apparatus transmits the third biometric information and the identity verification document to an identity verification server that provides an eKYC (electronic Know Your Customer) service and requests the identity verification of the user to the identity verification server.

8. The system according to claim 2, wherein the server apparatus stores membership information of the user if the user is registered as a member, determines that the identity verification is successful when a one-to-one matching using the third biometric information and the fourth biometric information is successful and when personal information acquired from the identity verification document and the membership information of the user registered in advance in the server apparatus are matched.

9. The system according to claim 1, wherein the terminal communicates with the authentication terminal through a short-range wireless communication.

10. The system according to claim 1, wherein the terminal communicates with the authentication terminal via Bluetooth (registered trademark).

11. The system according to claim 1, wherein the biometric information is a face image or a feature value generated from the face image.

12. An authentication terminal, comprising:
at least one memory storing a set of instructions; and
at least one processor configured to execute the set of instructions to:
receive a user information notification including first biometric information and qualification information from a terminal that stores the first biometric information of a user and the qualification information on a qualification required to receive a service;
acquire second biometric information of the user when the authentication terminal provides the service to the user;
identify the user to be provided the service by a matching processing using the acquired second biometric information and the first biometric information included in the user information notification and receive a result of a determination regarding a validity of the qualification information from a server apparatus by transmitting the qualification information of the identified user to the server apparatus; and
provide the service to the user when the qualification information is valid.

13. A control method of an authentication terminal, the control method comprising:
receiving a user information notification including first biometric information and qualification information from a terminal that stores the first biometric information of a user and the qualification information on a qualification required to receive a service;
acquiring second biometric information of the user when the authentication terminal provides the service to the user;
identifying the user to be provided the service by a matching processing using the acquired second biometric information and the first biometric information included in the user information notification and receiving a result of a determination regarding a validity of the qualification information from a server apparatus by transmitting the qualification information of the identified user to the server apparatus; and
providing the service to the user when the qualification information is valid.

14. (canceled)
